(19) United States
(12) Patent Application Publication
(10) Pub. No.: US 2004/0083617 A1
(43) Pub. Date: May 6, 2004

(54) Method and structure for installing an electrical device box

(76) Inventor: William Bielen, Madison Lake, MN (US)

Correspondence Address: MOORE, HANSEN & SUMNER, 2900 WELLS FARGO CENTER, 90 SOUTH SEVENTH STREET, MINNEAPOLIS, MN, 55402, US

(21) Appl. No.: 10/285,896

(22) Filed: Nov. 1, 2002

(51) Int. Cl. G01D 21/00

(52) U.S. Cl. 33/528

(57) ABSTRACT

A template for aligning and installing an electrical device box in a wall is herein disclosed. The template is a flat, planar plate having a peripheral edge and an interior cutout formed therethrough. The interior cutout is shaped to allow the insertion of the body of an electrical device box therein in close conformity therewith. At least one portion of the peripheral edge of the template is aligned with the interior cutout such that when the template is aligned with a mark on the wall, the interior cutout of the template will also be aligned with the mark. Tracing the inner cutout of the template onto a wall defines a cutout for the electrical device box. The template may be interposed between the electrical device box and the wall to act as a support flange for the installation of the electrical device box. A leveling device may be secured to the template to aid in aligning the template upon the wall.

### FIELD OF THE INVENTION

The present invention relates to a template that is useful in installing or retrofitting an electrical device box into a wall. The template may also be used as a support for installing the electrical device box.

### BACKGROUND OF THE INVENTION

Installing an electrical device box of the type commonly used to house electrical switches or outlets is a task that can easily go wrong. While installing the electrical device box itself is relatively simple, it can be difficult to properly align the device box with other features of the wall. In addition, if an installer is not careful, damage to the wall material may make it difficult to properly mount the electrical device box.

Accordingly, there is a recognized need for a template that not only assists an installer in properly aligning an electrical device box, but which also prevents unnecessary damage to the wall during installation and which can be used as a support for the electrical device box should there be damage to the wall.

These and other objectives and advantages of the invention will appear more fully from the following description, made in conjunction with the accompanying drawings wherein like reference characters refer to the same or similar parts throughout the several views.

### SUMMARY OF THE INVENTION

In its most basic form the present invention is realized in a template for defining the position of an electrical device box in a wall. The template comprises a flat planar body having a cutout formed therethrough. The cutout is defined by the shape of the electrical device box such that the electrical device box may be received through the interior cutout formed through the template. Preferably, the cutout is formed to be in close conformity with the exterior of the electrical device box. In addition, the template is generally smaller than a typical cover plate that is constructed and arranged for installation over the electrical device box.

In order to align the template, at least one portion of the outer peripheral edge of the template is aligned with the interior cutout formed through the template. As an alternative, at least one portion of the outer peripheral edge of the template may include a leveling device, such as a level vial, that may be formed integral therewith or removable. This leveling device is itself aligned with the interior cutout formed through the template.

The template is employed as follows. A location where the electrical device is to be installed is first located and a reference mark is made on the wall at that position. The template is next aligned on the wall using the alignment mark and the interior cutout of the template is traced onto the wall to define the periphery of a cutout that is to be formed through the wall. Note that the periphery of the cutout is aligned with the alignment mark on the wall. The portion of the wall within the traced periphery is then removed and the electrical device box is inserted into the resulting cutout. The electrical device box is then secured within the cutout using a standard clip or screw. Note that the electrical device box may be inserted into the interior cutout of the template before inserting the electrical device box into the cutout formed through the wall so that the template itself may act as a support flange for the device box. Wires and electrical devices may be installed in the electrical device box at any time after the cutout is formed through the wall.

Where the template is provided with an integral or removable leveling mechanism, the step of marking the wall to identify the aligned position of the electrical device box may be omitted as the leveling mechanism allows the device box position to be aligned and then traced in one step.

### DESCRIPTION OF THE DRAWINGS

FIG. 1 is a front view of an electrical device box installed in a cutout formed in a wall;

FIG. 2 is a front view of a template according to the present invention aligned upon a wall surface;

FIG. 3 is a side view of an electrical device box installed in a cutout formed through a wall and having the template installed therewith as a supporting element;

FIG. 4 is front view of the electrical device box installed in a cutout formed through a wall and having the template of the present invention installed therewith; and,

FIG. 5 illustrates an alternate embodiment of the template of the present invention incorporating a leveling mechanism.

### DETAILED DESCRIPTION

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

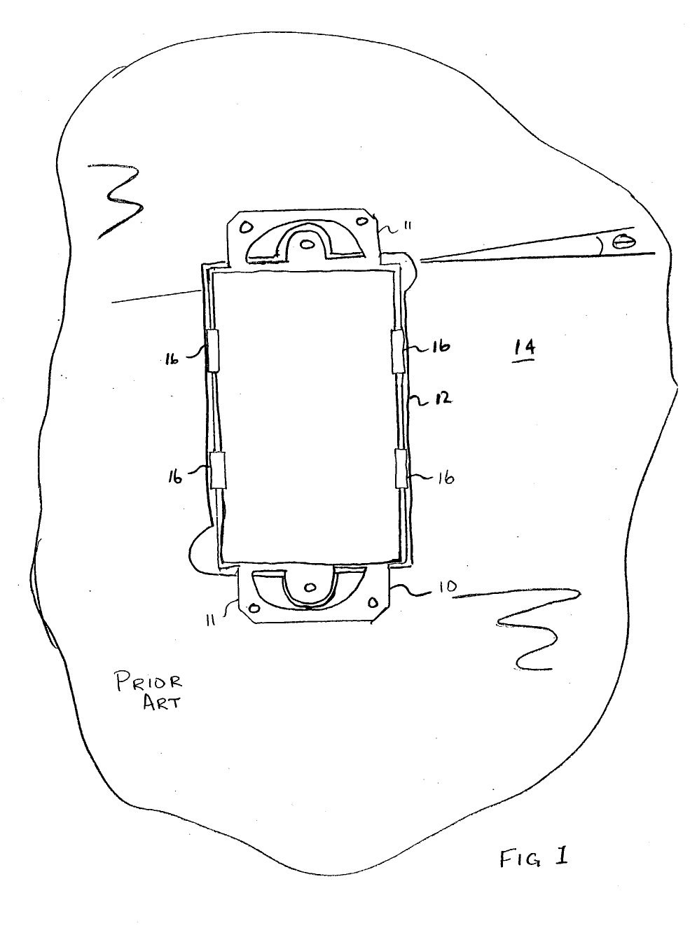

FIG. 1 illustrates a prior art method for installing an electrical device box 10 in a cutout 12 formed through a wall 14. In general, the box 10 would be placed on the wall 14 so that an outline of the box 10 could be traced onto the wall 14. The installer would then remove the box 10 and cut a hole in the wall 14 using an appropriate tool. Note that as used herein, wall 14 refers to any pre-existing wall, and particularly those walls made using gypsum board, drywall, plasterboard, or paneling. Tools that may be used to form the cutout 12 through the wall 14 may include, but are not limited to, rotary cutout tools and handsaws.

Once the cutout 12 was formed through the wall 14, the box 10 would be inserted into the cutout 12 and secured therein using a clip 16. Note that as used herein, the term “clip” should be construed broadly to include any mechanism or structure suitable for securing the box 10 within the cutout 12 formed through the wall 14.

As can be appreciated from FIG. 1, where the alignment of the box 10 with the wall 14 was not carefully done, it is likely that the box 10 will be misaligned with the wall 14. This misalignment is indicated by angle theta in FIG. 1.

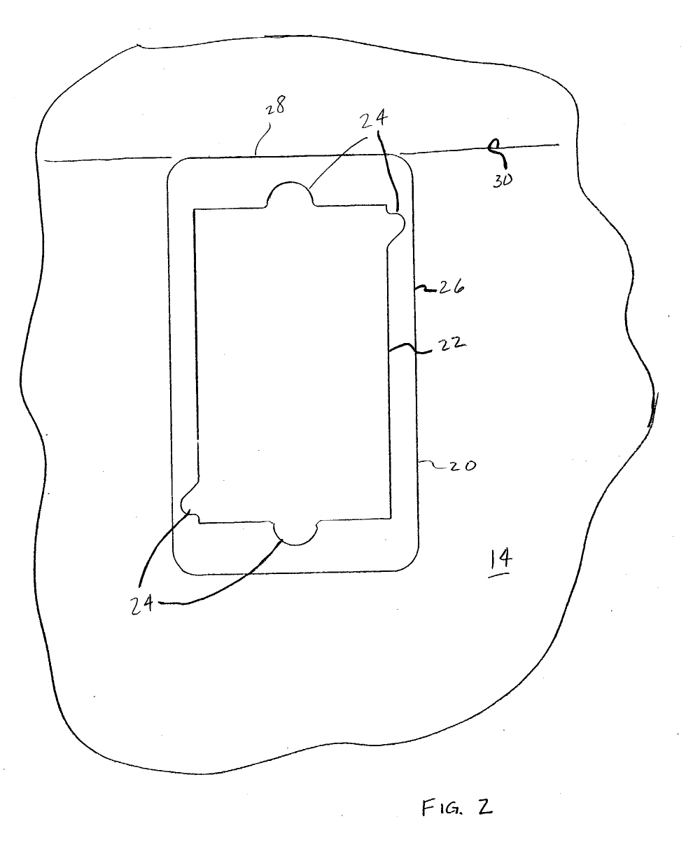

FIG. 2 illustrates a template 20 according to the present invention. The template 20 is made of a thin, relatively rigid material such as steel, aluminum, or plastic, and has an interior cutout 22 having a shape that is complementary to the exterior surface of the box 10. The interior cutout 22 is in fact the silhouette of the exterior of the box 10 and constructed and arranged such that when the template 20 is placed on a wall 14, a line traced around the interior cutout 22 will define the borders of the cutout 12 that must be formed through the wall 14 to accommodate the box 10. Note that various protrusions 24 are formed in the interior cutout 22 to accommodate various structural features of the exterior of the box 10. These protrusions 24 are designed to accommodate a particular box design but where different sizes, makes, and models of electrical device boxes 10 are used, the size and location of the protrusions 24 and the size and shape of the interior cutout 22 itself will vary. Accordingly, it is to be understood that the template and its interior cutout 22 may change in size and shape without exceeding the scope of the present invention.

The template 20 has an outer perimeter edge 26 that is aligned with the interior cutout 22 such that when the perimeter 26 is aligned with the wall 14 in a particular manner, the subsequently formed cutout 12 and the box 10 installed therein will be aligned in a known manner. In FIG. 2 the perimeter 26 of the template 20 is constructed and arranged such that when an upper edge 28 of the template 20 is aligned with level line 30, the subsequently formed cutout 12 and the box 10 installed therein will also be aligned with level line 30.

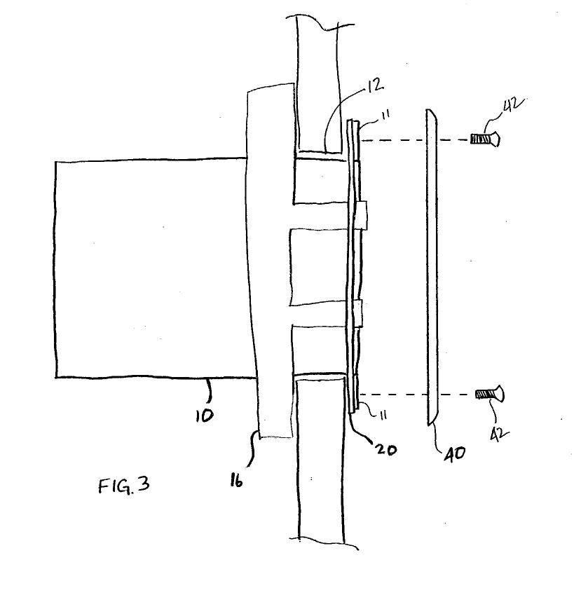

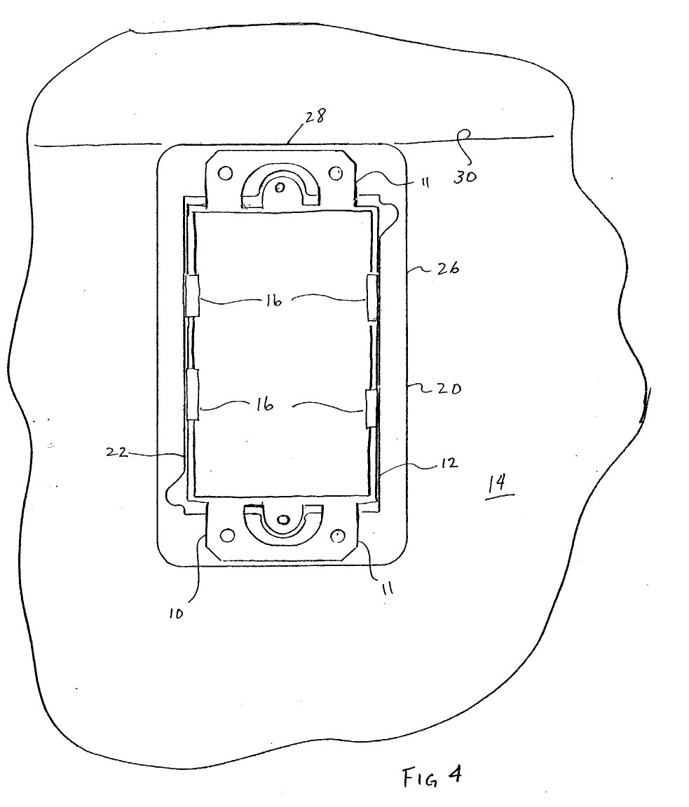

At times it may be difficult for an installer to form the cutout 12 as defined by the outline created using the interior cutout 22 of the template 20. Alternatively, at times the insertion of the box 10 into the cutout 12 may damage the wall 14 surrounding the cutout 12. In these instances, the box 10 may not be properly seated within the cutout 12 and/or may be misaligned or in danger of being inserted through an oversized cutout 12 formed in the wall 14. Where this occurs, the template 20 may serve as a support flange for the box 10 as illustrated in FIGS. 3 and 4. As the template 20 extends laterally from the inner cutout 22, the template 20 will bear on the surface of the wall 14 surrounding the cutout 12. The template 20 will bridge gaps and breakouts at the edges of the cutout 12 in order to firmly align the box 10 with the wall 14 and prevent the box 10 from being inserted entirely through the cutout 12. Preferably the periphery 26 of the template 20 will be sized so as to fit within a cover plate 40 such as that shown in FIG. 3. The cover plate 40 would be installed over the open front of the box 10 after an electrical device such as a switch or outlet (not shown) has been installed therein.

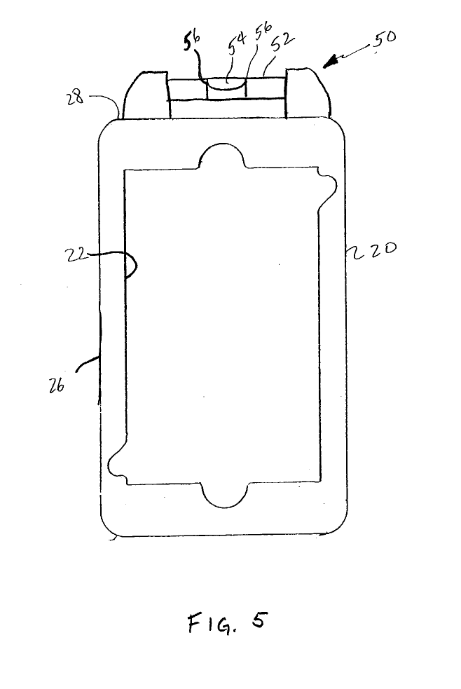

FIG. 5 illustrates an alternate embodiment of the present invention wherein the template 20 has a leveling mechanism 50 attached to its upper edge 28. The leveling device 50 comprises a vial 52 being filled with a liquid such as water or alcohol. The vial 52 also has an air bubble 54 therein. The vial 52 has a pair of marks 56 formed thereon that define a level position of the bubble 54. When the bubble 54 is between the marks 56, the leveling mechanism 50 and hence the template 20 to which it is attached are properly aligned with the wall 14 in a level position.

In operation an installer such as an electrician first determines the location upon the wall 14 where an electrical device box 10 is to be installed. Once the location has been determined, a reference line indicating how the box 10 is to be aligned on the wall 14 is drawn or otherwise marked on the wall on the wall 14. A template 20 is next aligned with this reference line and the periphery of the interior cutout 22 of the template 20 is traced onto the wall 14 using a pen or pencil or other marking tool. The template 20 is then removed from the wall 14 and the cutout 12 is formed by removing that portion of the wall within the traced outline of the inner cutout 22. Once the cutout 12 has been formed, the electrical device box 10 may be inserted directly into the cutout 12 and secured there using the clip 16. However, where there has been damage to the wall 14 surrounding the cutout such that the box 10 cannot be properly seated within the cutout 12, the template 20 will be first assembled with the device box such that the when the box 10 is inserted into the cutout 12, the template 20 will be interposed between the surface of the wall 14 and the flanges 11 that extend from the body of the device box 10. Clip 16 would then be installed in order to secure the box 10 and the template 20, where indicated, into the cutout 12. Note that wires, cables, or other conductors may be pulled into or inserted through the box 10 at any point during the installation of the box 10 into the wall 14. Once the box 10 is installed in the cutout 12 in the wall 14, an electrical device such as an outlet or a switch (not shown) will be installed therein in a known manner. A cover 40 will then be attached to the box 10, typically by means of a pair of screws 42.

Where a template 20 is provided with a leveling mechanism 50, the step of aligning the template 20 with respect to the wall 14 will involve positioning the template 20 on the wall 14 until such time as the air bubble 54 within the vial 52 is positioned between the marks 56 formed on the vial 52. At this point the template 20 will be properly aligned with the wall 14 and the outline of the cutout 12 may be traced on the wall 14. Note that a template 20 that does not include the leveling mechanism 50 may be used in conjunction with the box 10 to assist with the installation thereof where there has been damage to the wall 14. However, where the leveling mechanism 50 may be temporarily attached to the template 20, the leveling mechanism 50 may be removed from the template 20 so that the template 20 may be installed with the box 10.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A template for defining the position of an electrical device box in a wall, the template comprising:
a flat planar body having a cutout formed therethrough, the cutout being defined by the shape of the electrical device box such that the electrical device box may be received through the interior cutout formed through the template.

2. The template for defining the position of an electrical device box in a wall of claim 1 wherein the interior cutout is formed to be in close conformity with the exterior of the electrical device box.

3. The template for defining the position of an electrical device box in a wall of claim 1 wherein an outer peripheral edge of the template is smaller than a cover plate constructed and arranged for installation over the electrical device box.

4. The template for defining the position of an electrical device box in a wall of claim 3 wherein at least one portion of the outer peripheral edge of the template is aligned with the interior cutout formed through the templates;

5. The template for defining the position of an electrical device box in a wall of claim 4 wherein the at least one portion of the outer peripheral edge of the template further includes a leveling device.

6. A template for defining the position of an electrical device box in a wall, the template comprising:
a flat planar body having an outer periphery and a cutout formed therethrough, at least one portion of the outer periphery of the body being aligned with the cutout, the cutout formed to be in close conformity with the exterior of the electrical device box such that the electrical device box may be received through the cutout.

7. The template for defining the position of an electrical device box in a wall of claim 6 wherein the at least one portion of the outer peripheral edge of the template further includes a removable leveling device.

8. A method of installing an electrical device box in a wall comprising the steps of:
identifying a location where the electrical device is to be installed;
making a reference mark on the wall at the position where the electrical device box is to be installed;
aligning a template on the wall using the alignment mark;
tracing an interior cutout of the template so as to define the periphery of a cutout to be formed through the wall, the periphery of the cutout being aligned with the alignment mark on the wall;
removing that portion of the wall within the periphery for the cutout that was traced on the wall;
inserting the electrical device box into the cutout formed through the wall; and,
securing the electrical device box within the cutout.

9. The method of installing an electrical device box in a wall of claim 8 further including the step of inserting the electrical device box into the interior cutout of the template before inserting the electrical device box into the cutout formed through the wall.

10. A method of installing an electrical device box in a wall comprising the steps of:
identifying a location where the electrical device is to be installed;
aligning a template on the wall using a leveling mechanism attached to the template;
tracing an interior cutout of the template so as to define the periphery of a cutout to be formed through the wall, the periphery of the cutout being aligned with the alignment mark on the wall;
removing that portion of the wall within the periphery for the cutout that was traced on the wall;
inserting the electrical device box into the cutout formed through the wall; and,
securing the electrical device box within the cutout.
